(19) United States
(12) Patent Application Publication
(10) Pub. No.: US 2021/0179493 A1
(43) Pub. Date: Jun. 17, 2021

(54) METHOD FOR TREATMENT OF SLAG

(71) Applicant: CONSTRUCTION RESEARCH & TECHNOLOGY GMBH, Trostberg (DE)

(72) Inventors: Peter SCHWESIG, Trostberg (DE); Madalina STEFAN, Trostberg (DE); Luc NICOLEAU, Villevaude (FR); Alexander KRAUS, Trostberg (DE)

(73) Assignee: Construction Research & Technology GmbH, Trostberg (DE)

(21) Appl. No.: 16/093,220

(22) PCT Filed: Apr. 28, 2017
(86) PCT No.: PCT/EP2017/060164

§ 371 Date: Oct. 12, 2018

(30) Foreign Application Priority Data
May 9, 2016 (EP) 16168751.2

(51) Int. Cl. C04B 28/08; C04B 18/14; C04B 7/153; C04B 20/02; B02C 4/10; B02C 23/06

(52) U.S. Cl. CPC C04B 28/08; C04B 18/141; B02C 23/06; C04B 20/026; B02C 4/10; C04B 7/153

(57) ABSTRACT

The invention relates to a process for the wet milling of slag, wherein more than 100 kWh of milling energy are introduced per metric ton of slag and the weight ratio of slag to water is 0.05-4:1 and from 0.005 to 2% by weight, based on the slag, of a milling auxiliary which comprises at least one compound selected from the group consisting of polycarboxylate ether, phosphated polycondensation product, lignosulfonate, melamine-formaldehyde sulfonate, naphthalene-formaldehyde sulfonate, monoglycols, diglycols, triglycols and polyglycols, polyalcohols, alkanolamine, amino acids, sugar, molasses and curing accelerators based on calcium silicate hydrate is added to the material being milled before or during the milling.

The invention relates to a process for the treatment of slag, the product obtained from the process and also the use thereof.

The term hydraulic refers to materials which cure both in air and also under water and are water-resistant. In particular, hydraulic binders are cement and pozzolanas such as fly ash and blast furnace slag.

Among hydraulic binders, cement has the greatest economic importance. Mixed with water, cement gives cement paste which solidifies and cures by hydration and also remains solid and dimensionally stable after curing under water. Cement consists essentially of portland cement clinker and can further comprise, for example, slag sand, possolana, fly ash, limestone, fillers and cement additives. The cement constituents have to be statistically homogeneous in terms of their composition, which can, in particular, be achieved by means of adequate milling and homogenization processes.

In industry, cement and the raw materials for cement production are milled mainly in tubular ball mills in which the effect of milling auxiliaries is of particular importance.

For clinker production, the cement raw materials are generally dry milled. In the dry treatment, the raw material components are fed in a particular mixing ratio by means of metering devices into a mill and finely milled to give raw meal. The raw meal is subsequently fired at about 1450° C., forming clinker. Good milling of the raw materials is critical for the quality of the clinker. The now spherical material is cooled and milled together with slag sand, fly ash, limestone and gypsum to give the end product cement.

The production of cement is a very energy-intensive and thus expensive process in which large quantities of carbon dioxide are liberated. Both for economic reasons and also ecological reasons, it is therefore of great interest to use alternative raw materials as substitute for cement.

Slag has been used as secondary raw material in the building sector for a long time. It is a by-product which is obtained, in particular, from iron blast furnace operations. The blast furnace is conventionally charged with layers of iron ore, additional lime, fuel and other sources of iron oxide as part of a highly controlled metallurgical process. Heat and oxygen are introduced into the furnace in order to attain very high temperatures and molten iron is collected by tapping the lower region of the furnace. Molten slag which is formed directly above the molten iron is likewise tapped off and taken from the furnace, and is then quenched with water in order to produce a moist granulated slag material.

The granulated blast furnace slag is a nonmetallic product which comprises mainly silicates and aluminosilicates of calcium and other bases. ASTM C-989 provides specifications for granulated slag which can be used in concrete and mortar compositions, and ASHTO-MR02 provides the specification for the milled product which can be formed from the granulated slag and is used as component in blended cements (e.g. ASTM C-595 Standard Specifications for Blended Hydraulic Cements).

Blended cement compositions can be formed by replacing part (up to about 50% by weight) of the hydraulic cement component of the composition by a milled pulverulent slag product. The cement compositions of mortar (hydraulic cement, fine aggregate such as sand and water) and concrete (hydraulic cement, fine aggregate, coarse aggregate such as stone and water) generally display increased late strength when slag is present as part of the composition.

Granulated slag is normally treated by means of a ball mill or roller press in order to give the pulverized product. In the ball milling process, the granules are treated by continuous statistical impacts of the ball elements of the mill in order to break up the granules to give the desired powder. The ball mill operates with greater efficiency when an agent (generally referred to as “milling auxiliary”) which leads to the particles formed remaining in dispersed form in the ball mill is present in the mill. Compounds such as lignosulfonates, triethanolamine and the like have therefore been used in ball milling processes.

The roller press operates according to a quite different mechanism than the ball mill. The slag granules are fed into the gap of a pair of rollers. The granules are subjected to a single crushing force which takes place when the granules pass through between the rollers. The rollers crush the granules, which leads to them breaking into very small particles, and fracture of the granules is also brought about so that the granules disintegrate completely when they are subsequently treated in a deagglomerator.

DE 69610562 discloses a process for producing milled slag powders by means of a roller press with addition of (a) from 0.002 to 0.3% by weight of polymer selected from among polyacrylic acid, alkali metal salt of polyacrylic acid and mixtures thereof, with the polymer having an average molecular weight (weight average) of at least 25 000, and (b) from 0.1 to 4% by weight of water, based on the total weight of the slag feed stream.

WO 2007/105029 describes a process for producing milled slag powders having increased reactivity, in which granulated slag is milled in a wet process in a stirred ball mill. The product obtained starts to hydrate within 48 hours and is completely hydrated within 28 days. However, a disadvantage is that the early strength of the product obtained in this way is lower than that of cement.

It was therefore an object of the present invention to provide a process for milling slag, which gives a highly reactive product which can completely replace portland cement in mortars and concrete. Furthermore, the process should give a product which in all aging stages has strength properties at least comparable to those of portland cement.

This object is achieved by a process for the wet milling of slag, wherein more than 100 kWh, in particular more than 180 kWh, particularly preferably from 200 to 2000 kWh, in particular from 300 to 1000 kWh, of milling energy are introduced per metric ton of slag and the weight ratio of slag to water is 0.05-4:1 and from 0.005 to 2% by weight, preferably from 0.01 to 0.5% by weight, particularly preferably from 0.05 to 0.5% by weight, based on the slag, of a milling auxiliary comprising at least one compound from the group consisting of polycarboxylate ether, phosphated polycondensation product, lignosulfonate, melamine-formaldehyde sulfonate, naphthalene-formaldehyde sulfonate, monoglycols, diglycols, triglycols and polyglycols, polyalcohols, alkanolamine, amino acids, sugar, molasses and curing accelerators based on calcium silicate hydrate is added to the material being milled before or during the wet milling.

It has surprisingly been found that the process of the invention gives a slag which, either alone or as a mixture with other inorganic binders, in particular portland cement, attains, after mixing with water, a very high early strength after one and two days and also an excellent late strength after 28 days. The early strength properties of pure portland cement are substantially exceeded by the products produced according to the invention.

The slag used according to the invention is particularly preferably blast furnace slag.

In a preferred embodiment, the slag used in the process of the invention has the following composition: from 20 to 50% by weight of SiO₂, from 5 to 40% by weight of Al₂O₃, from 0 to 3% by weight of Fe₂O₃, from 20 to 50% by weight of CaO, from 0 to 20% by weight of MgO, from 0 to 5% by weight of MnO, from 0 to 2% by weight of SO₃ and >80% by weight of glass content. The slag particularly preferably has the following composition: from 30 to 45% by weight of SiO₂, from 5 to 30% by weight of Al₂O₃, from 0 to 2% by weight of Fe₂O₃, from 30 to 50% by weight of CaO, from 0 to 15% by weight of MgO, from 0 to 5% by weight of MnO, from 0 to 1% by weight of SO₃ and >90% by weight of glass content.

In the process of the invention, particular preference is given to the weight ratio of slag to water being 0.1-3:1, in particular 0.5-2:1 and particularly preferably 0.4-0.6:1.

Preference is here given to using milling media in the wet milling, with the weight ratio of slag to milling media being 1-20:1, particularly preferably 14-16:1.

The milling media are, in particular, configured as balls, with a diameter of the balls of from 0.5 to 3 mm being preferred.

As regards the time for which the slag is wet milled, from 10 minutes to 3 hours, preferably from 1 to 2 hours, have been found to be particularly advantageous.

In particular, the wet milling can be carried out in a stirred ball mill. The stirred ball mill comprises a milling chamber comprising milling media, a stator and a rotor which are arranged in the milling chamber. The stirred ball mill also preferably comprises an inlet opening and an outlet opening for introducing and discharging material being milled into or from the milling chamber and also a milling media separation device which is arranged in the milling chamber upstream of the outlet opening and serves to separate milling media entrained in the material being milled from the material being milled before the latter is discharged through the outlet opening from the milling space. In order to increase the mechanical milling power introduced into the material being milled in the milling chamber, pins which project into the milling space are preferably present on the rotor and/or on the stator. During operation, a contribution to the milling power is thus firstly produced directly by impacts between the material being milled and the pins. Secondly, a further contribution to the milling power is produced indirectly by impacts between the pins and the milling media entrained in the material being milled and then in turn impacts between the material being milled and the milling media. Finally, shear forces and stretching forces acting on the material being milled also contribute to comminuting the suspended particles of material being milled.

Depending on the milling energy introduced, the slag obtained from the milling according to the invention has a different particle size distribution and total surface area, which is also referred to as fineness. The particle size distribution of inorganic solids is typically reported according to the Blaine method in cm²/g. Both the fineness and the particle size distribution are of great relevance in practice. Such particle size analyses are usually carried out by laser granulometry or air classification. The milling time for achieving the desired fineness can be significantly reduced by use of the milling auxiliaries according to the invention.

The particle size d₅₀ of the slag obtained from the milling according to the invention is preferably less than 10 μm, in particular less than 5 μm, preferably less than 3 μm and particularly preferably less than 2 μm, measured by laser granulometry using a MasterSizer® 2000 from Malvern Instruments Ltd.

In particular, the milling auxiliary can be at least one compound selected from the group consisting of polycarboxylate ether and phosphated polycondensation product, where the milling auxiliary comprises a structural unit (I),

*—U—(C(O))ₖ—X-(AlkO)ₙ—W (I)

where
* indicates the point of bonding to the polymer comprising acid groups,
U is a chemical bond or an alkylene group having from 1 to 8 carbon atoms,
X is oxygen, sulfur or an NR¹ group,
k is 0 or 1,
n is an integer having an average, based on the polymer comprising acid groups, in the range from 1 to 300,
Alk is C₂-C₄-alkylene, where Alk can be identical or different within the group (Alk-O)ₙ,
W is a hydrogen radical, a C₁-C₆-alkyl radical or an aryl radical or the group Y—F, where
Y is a linear or branched alkylene group which has from 2 to 8 carbon atoms and can bear a phenyl ring,
F is a 5- to 10-membered nitrogen heterocycle which is bound via nitrogen and can have, apart from the nitrogen atom and apart from carbon atoms, 1, 2 or 3 additional heteroatoms selected from among oxygen, nitrogen and sulfur as ring members, where the nitrogen ring members can bear an R² group and 1 or 2 carbon ring members can be present as carbonyl group,
R¹ is hydrogen, C₁-C₄or benzyl and
R² is hydrogen, C₁-C₄or benzyl.

In a preferred embodiment, the phosphated polycondensation product comprises

(II) a structural unit having an aromatic or heteroaromatic and a polyether group and

also

(III) a phosphated structural unit having an aromatic or heteroaromatic.

The structural units (II) and (III) are preferably represented by the following general formulae

A-U—(C(O))ₖ—X-(AlkO)ₙ—W (II)

where

the radicals A are identical or different and are represented by a substituted or unsubstituted aromatic or heteroaromatic compound having from 5 to 10 carbon atoms in the aromatic system, where the further radicals have the meanings indicated for structural unit (I);

A-U—(C(O))ₖ—X-(AlkO)ₙ—P(O)(OMₐ)₂ (III)
where
the radicals A are identical or different and are represented by a substituted or unsubstituted aromatic or heteroaromatic compound having from 5 to 10 carbon atoms in the aromatic system, where the further radicals have the meanings indicated for structural unit (I) and
   M is hydrogen, a monovalent, divalent or trivalent metal cation, an ammonium ion or an organic amine radical,
   a is ⅓, ½ or 1.

The polycondensation product preferably comprises a further structural unit (IV) which is represented by the following formula

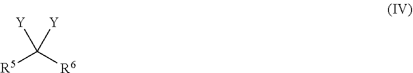

where

the radicals Y are, independently of one another, identical or different and are represented by (II), (III) or further constituents of the polycondensation product.

R⁵ and R⁶ are preferably identical or different and represented by H, methyl, ethyl, propyl, COOH or a substituted or unsubstituted aromatic or heteroaromatic compound having from 5 to 10 carbon atoms. Here, R⁵ and R⁶ in the structural unit (IV) are, independently of one another, preferably represented by H, COOH and/or methyl. In a particularly preferred embodiment, R⁵ and R⁶ are represented by H.

The molar ratio of the structural units (II), (III) and (IV) of the phosphated polycondensation product according to the invention can be varied within a wide range. It has been found to be advantageous for the molar ratio of the structural units [(II)+(III)]:(IV) to be 1:0.8-3, preferably 1:0.9-2 and particularly preferably 1:0.95-1.2.

The molar ratio of the structural units (II):(III) is normally from 1:10 to 10:1, preferably from 1:7 to 5:1 and particularly preferably from 1:5 to 3:1.

The groups A and D in the structural units (II) and (III) of the polycondensation product are usually represented by phenyl, 2-hydroxyphenyl, 3-hydroxyphenyl, 4-hydroxyphenyl, 2-methoxyphenyl, 3-methoxyphenyl, 4-methoxyphenyl, naphthyl, 2-hydroxynaphthyl, 4-hydroxynaphthyl, 2-methoxynaphthyl, 4-methoxynaphthyl, preferably phenyl, where A and D can be selected independently of one another and can in each case also consist of a mixture of the compounds mentioned. The groups X and E are, independently of one another, preferably represented by O.

Preference is given to n in the structural unit (I) being represented by an integer from 5 to 280, in particular from 10 to 160 and particularly preferably from 12 to 120, and b in the structural unit (III) being represented by an integer from 0 to 10, preferably from 1 to 7 and particularly preferably from 1 to 5. The respective radicals, whose length is defined by n and b, respectively, can here consist of uniform structural components but it can also be advantageous for them to be a mixture of different structural components. Furthermore, the radicals of the structural units (II) and (III) can, independently of one another, each have the same chain length, with n or b in each case being represented by a number. However, it will generally be advantageous for them in each case to be mixtures having different chain lengths, so that the radicals of the structural units in the polycondensation product have different numerical values for n and independently for b.

In a particular embodiment, the present invention further provides for a sodium, potassium, ammonium and/or calcium salt, preferably a sodium and/or potassium salt, of the phosphated polycondensation product to be present.

The phosphated polycondensation product according to the invention frequently has a weight average molecular weight of from 4000 g/mol to 150 000 g/mol, preferably from 10 000 to 100 000 g/mol and particularly preferably from 20 000 to 75 000 g/mol.

As regards the phosphated polycondensation products which are preferably to be used for the purposes of the present invention and the preparation thereof, reference is also made to the patent applications WO 2006/042709 and WO 2010/040612, the contents of which are hereby incorporated by reference into this patent application.

In a further preferred embodiment, the polycarboxylate ether according to the invention is at least one copolymer obtainable by polymerization of a mixture of monomers comprising
(V) at least one ethylenically unsaturated monomer which comprises at least
   one radical selected from the group consisting of carboxylic acid, carboxylic acid salt, carboxylic ester, carboxamide, carboxylic anhydride and carboximide
   and
(VI) at least one ethylenically unsaturated monomer having
   a structural unit (I).

The copolymers corresponding to the present invention comprise at least two monomer building blocks. However, it can also be advantageous to use copolymers having three or more monomer building blocks.

In a preferred embodiment, the ethylenically unsaturated monomer (V) is represented by at least one of the following general formulae from the group (Va), (Vb) and (Vc):

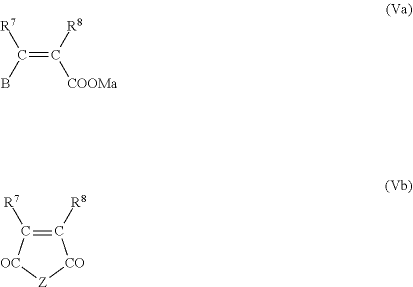

In the monocarboxylic or dicarboxylic acid derivative (Va) and the monomer (Vb) present in cyclic form, where Z═O (acid anhydride) or NR¹⁶ (acid imide), R⁷ and R⁸ are each, independently of one another, hydrogen or an aliphatic hydrocarbon radical having from 1 to 20 carbon atoms, preferably a methyl group. B is H, —COOMₐ, —CO—O(C_{q}H_{2q}O)ᵣ—R⁹, —CO—NH—(C_{q}H_{2q}O)ᵣ—R⁹.

M is hydrogen, a monovalent, divalent or trivalent metal cation, preferably a sodium, potassium, calcium or magnesium ion, or else ammonium or an organic amine radical, and a=⅓, ½ or 1, depending on whether M is a monovalent, divalent or trivalent cation. As organic amine radicals, preference is given to using substituted ammonium groups which are derived from primary, secondary or tertiary C₁₋₂₀-alkylamines, C₁₋₂₀-alkanolamines, C₅₋₈-cycloalkylamines and C₆₋₁₄-arylamines. Examples of the corresponding amines are methylamine, dimethylamine, trimethylamine, ethanolamine, diethanolamine, triethanolamine, methyldiethanolamine, cyclohexylamine, dicyclohexylamine, phenylamine, diphenylamine in the protonated (ammonium) form.

R⁹ is hydrogen, an aliphatic hydrocarbon radical having from 1 to 20 carbon atoms, a cycloaliphatic hydrocarbon radical having from 5 to 8 carbon atoms, an aryl radical which has from 6 to 14 carbon atoms and may optionally be substituted, q=2, 3 or 4 and r=0 to 200, preferably from 1 to 150. The aliphatic hydrocarbons can be linear or branched and saturated or unsaturated. Preferred cycloalkyl are cyclopentyl or cyclohexyl radicals, while preferred aryl radicals are phenyl or naphthyl radicals which can, in particular, be substituted by hydroxyl, carboxyl or sulfonic acid groups.

Furthermore, Z is O or NR¹⁶, where the radicals R¹⁶ are, independently of one another, identical or different and are each represented by a branched or unbranched C₁-C₁₀-alkyl radical, C₅-C₈-cycloalkyl radical, aryl radical, heteroaryl radical or H.

The following formula represents the monomer (Vc):

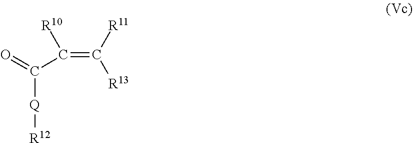

Here, R¹⁰ and R¹¹ are each, independently of one another, hydrogen or an aliphatic hydrocarbon radical having from 1 to 20 carbon atoms, a cycloaliphatic hydrocarbon radical having from 5 to 8 carbon atoms, an optionally substituted aryl radical having from 6 to 14 carbon atoms.

Furthermore, the radicals R¹² are identical or different and are each represented by (CₙH₂ₙ)—SO₃Mₐ where n=0, 1, 2, 3 or 4, (CₙH₂ₙ)—OH where n=0, 1, 2, 3 or 4; (CₙH₂ₙ)—PO₃(Mₐ)₂ where n=0, 1, 2, 3 or 4, (CₙH₂ₙ)—OPO₃(Mₐ)₂ where n=0, 1, 2, 3 or 4, (C₆H₄)—SO₃Mₐ, (C₆H₄)—PO₃(Mₐ)₂, (C₆H₄)—OPO₃(Mₐ)₂ and (CₙH₂ₙ)—NR¹⁴_{b} where n=0, 1, 2, 3 or 4 and b=2 or 3 and M is hydrogen, a monovalent, divalent or trivalent metal cation, ammonium ion or an organic amine radical and a is ⅓, ½ or 1.

R¹³ is H, —COOMₐ, —CO—O(C_{q}H_{2q}O)ᵣ—R⁹, —CO—NH—(C_{q}H_{2q}O)ᵣ—R⁹, where Mₐ, R⁹, q and r are as defined above.

R¹⁴ is hydrogen, an aliphatic hydrocarbon radical having from 1 to 10 carbon atoms, a cycloaliphatic hydrocarbon radical having from 5 to 8 carbon atoms, an optionally substituted aryl radical having from 6 to 14 carbon atoms.

Furthermore, the radicals Q are identical or different and are each represented by NH, NR¹⁵ or O, where R¹⁵ is an aliphatic hydrocarbon radical having from 1 to 10 carbon atoms, a cycloaliphatic hydrocarbon radical having from 5 to 8 carbon atoms or an optionally substituted aryl radical having from 6 to 14 carbon atoms.

In a particularly preferred embodiment, the ethylenically unsaturated monomer (VI) is represented by the following general formula

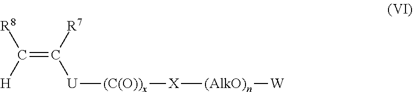

where all radicals are as defined above.

The average molecular weight M_{w} of the polycarboxylate ether according to the invention as determined by gel permeation chromatography (GPC) is preferably from 5000 to 200 000 g/mol, particularly preferably from 10 000 to 80 000 g/mol and very particularly preferably from 20 000 to 70 000 g/mol. The polymers were analyzed by means of size exclusion chromatography to determine their average molar mass and conversion (column combinations: OH-Pak SB-G, OH-Pak SB 804 HQ and OH-Pak SB 802.5 HQ from Shodex, Japan; eluent: 80% by volume of aqueous solution of HCO₂NH₄ (0.05 mol/l) and 20% by volume of acetonitrile; injection volume 100 μl; flow rate 0.5 ml/min). Calibration to determine the average molar mass was carried out using linear polyethylene glycol standards.

The copolymer according to the invention preferably satisfies the requirements of the industrial standard EN 934-2 (February 2002).

In a particularly preferred embodiment, the milling auxiliary comprises a curing accelerator based on calcium silicate hydrate. Preference is given here to the particle size d₅₀ of the curing accelerator based on calcium silicate hydrate being less than 5 μm, measured by light scattering preferably using a MasterSizer® 2000 from Malvern Instruments Ltd.

The curing accelerator based on calcium silicate hydrate can, in particular, be obtained by a process in which a water-soluble calcium salt is reacted with a water-soluble silicate compound in the presence of water and a polymeric dispersant.

As regards the curing accelerators based on calcium silicate hydrate which are preferably to be used according to the present invention and the preparation thereof, reference is also made to the patent applications WO2010/026155, WO2011/026720 and WO2011/026723, the contents of which are hereby incorporated by reference into this application.

The present invention further provides a milled slag which is obtained by the process of the invention, wherein the milled slag comprises the milling auxiliary. The process for producing the slag according to the invention thus does not comprise any step for the complete removal of the milling auxiliary used.

Furthermore, the present invention provides for the use of a slag obtained by the process of the invention as binder or in a binder composition, wherein the binder component preferably comprises from 5 to 100% by weight of the slag according to the invention. The binder component particularly advantageously also comprises cement, in particular portland cement, wherein the binder component preferably comprises from 5 to 99% by weight of slag and from 1 to 95% by weight of cement. In particular, in binder compositions in which cement, in particular portland cement, and/or microsilica and/or metakaolin were previously used, these binders can be replaced completely or at least partly by the slag according to the invention.

In a further embodiment, the present invention provides for the use of a slag according to the invention in a cement-based composition in an amount of from 0.1 to 99% by weight, in particular from 1 to 50% by weight, based on the dry mass. The cement-based composition can, in particular, be concrete or cement.

In a further preferred embodiment, the present invention provides for the use of a slag obtained by the process of the invention in a binder composition, wherein the binder component further comprises at least one alkali-activated aluminosilicate binder. The binder component preferably comprises from 5 to 99% by weight of slag and from 1 to 95% by weight of the alkali-activated aluminosilicate binder. Alkali-activated aluminosilicate binders are understood to mean cement-like materials which are formed by reaction of at least two components. The first component is a reactive solid component comprising SiO₂ and Al₂O₃, e.g. fly ash or metakaolin. The second component is an alkaline activator, e.g. sodium water glass or sodium hydroxide. In the presence of water, contact of the two components leads to curing by forming an aluminosiliceous, amorphous to partially crystalline network which is resistant to water.

An overview of the substances which come into question for the purposes of the present invention as alkali-activatable aluminosilicate binders is given in the literature reference Alkali-Activated Cements and Concretes, Caijun Shi, Pavel V. Krivenko, Della Roy, (2006), 30-63 and 277-297.

The binder composition is preferably a dry mortar. The continual search for far-reaching rationalization and also improved product quality has led to mortar for a wide variety of uses in the building sector nowadays virtually no longer being mixed from the starting materials on the building site itself. This task has nowadays largely been taken over by the factory in the building industry and the ready-to-use mixtures are made available as factory dry mortars. Here, finished mixtures which are made processable on the building site exclusively by addition of water and mixing are referred to, in accordance with DIN 18557, as factory mortars, in particular as factory dry mortars.

Such mortar systems can meet a wide variety of physical building tasks. Depending on the intended task, further additives are added to the binder, which can comprise cement and/or lime and/or calcium sulfate in addition to the slag according to the invention, in order to adapt the factory dry mortar to the specific use. Such additives can be, for example, shrinkage reducers, expanders, accelerators, retarders, dispersants, thickeners, antifoams, air pore formers, corrosion inhibitors.

The factory dry mortar according to the invention can be, in particular, masonry mortar, rendering mortar, mortar for thermal insulation composite systems, renovation renders, joint grouts, tile adhesives, thin-bed mortars, screed mortars, embedding mortars, injection mortars, knifing fillers, sealing slurries, repair mortars or lining mortars (e.g. for mains water pipes). Furthermore, the slag according to the invention can also be used in concrete. A further application is the use of the slag according to the invention in facing concrete for concrete paving stones.

In particular, it has been found that the slag according to the invention leads, when used in binder compositions, to improved aging resistance after curing of the components produced, in particular improved sulfate resistance, freeze-thaw resistance, chloride resistance and a reduction of efflorescences on the component surface.

The following examples illustrate the advantages of the present invention.

### EXAMPLES

General Experimental Method

12 kg of a granulated slag sand (Hüttensand Salzgitter GmbH & Co. KG) are milled in a drum ball mill for 110 minutes to a specific surface area of 3500 cm²/g (Blaine method). A suspension is produced from 700 g of the milled slag sand having a specific surface area of 3500 cm²/g and 1421 g of deionized water to which 0.1% by weight of a milling auxiliary according to the invention, based on the milled slag sand, are optionally added. This suspension is transferred into a stirring vessel of a stirred ball mill having perforated plates (Drais Pearl Mill) and the mill is operated at 2580 rpm with circulation. The volume of the milling chamber is 0.94 liters. Balls made of zirconium oxide and having a diameter of 0.8 mm are used as milling media. The degree of fill of the milling chamber with the milling media is 75%, with the weight ratio of slag to milling media being 0.066:1 and the milling time being about 2 hours. A calculated 750 kWh of milling energy are introduced per metric ton of slag by the wet milling.

The milling media are subsequently separated from the suspension by sieving. To separate off the slag sand from the suspension, the suspension is filtered through a glass fiber filter (Whatman glass fiber filter GF/F) by means of a suction bottle and the filter cake is covered with isopropanol.

The material is subsequently dried in a stream of nitrogen at 40° C.

The dry product obtained is brushed through a 250 μm sieve and mixed in a weight ratio of 50:50 with a commercially available CEM I 42.5N (Schwenk Zement KG, Mergelstetten works).

### Use Example

The production of the mortar for the strength testing is carried out in accordance with EN196-1 with additional introduction of a plasticizer in order to attain a slump flow of the mortar of about 20 cm. 225 g of water are mixed with 450 g of the binder consisting of pure CEM I 42.5 R (Schwenk Zement KG, Mergelstetten works) or of a mixture of this cement with slag sand in a mixer in accordance with EN 196-1 (w/c=0.5) and, after the time indicated in EN 196-1, 1350 g of CEN standard sand, EN 196-1, are added (c/s=0.33) and mixed according to the mixing regime specified in EN196-1.

The slump flow in accordance with EN 196-1 is subsequently set to about 20 cm by addition of a polycarboxylate ether plasticizer (Master ACE 430, trade name of BASF Construction Solutions GmbH).

Compressive strength testing was carried out in accordance with EN 196-1.

TABLE 1
Testing of the compressive strength

| | | Compressive strength [MPa] | | |
|---|---|---|---|---|
| Experiment | d₅₀ [μm] | 1 day | 2 days | 28 days |
| E1 | — | 10.7 | 19.2 | 63.6 |
| E2 | 17.5 | 2.9 | 6.7 | 50.5 |
| E3 | 8.3* | 10.1 | 25.8 | 65.2 |
| E4 | 6.3* | 18.5 | 42.3 | 69.9 |
| E5 | 1.7* | 20.6 | 44.6 | 68.8 |
| E6 | 1.9* | 1.1 | 3.2 | 10.7 |
| E7 | 2.5* | 1.2 | 3.3 | 10.1 |

The determination of the d₅₀ of the slag sand is carried out by means of laser light scattering (Malvern Mastersizer 2000).
*in aqueous suspension
E1 (comparison): Exclusively CEM I 42.5N (Schwenk Zement KG, Mergelstetten works) is used as binder.
E2 (comparison): Slag sand (Hüttensand Salzgitter GmbH & Co. KG) having a specific surface area of 3500 cm²/g is used as binder.
E3 (comparison): A binder produced according to the general experimental method is used, with no milling auxiliary being employed.
E4 (according to the invention): A binder produced according to the general experimental method is used, with 0.1% by weight, based on the milled slag sand, of a curing accelerator based on calcium silicate hydrate (Master XSEED100, trade name of BASF Construction Solutions GmbH) being used as milling auxiliary.
E5 (according to the invention): A binder produced according to the general experimental method is used, with 0.1% by weight, based on the milled slag sand, of a phosphated polycondensation product (MasterEase 3000, trade name of BASF Construction Solutions GmbH) being used as milling auxiliary.
E6 (comparison): A binder produced according to the general experimental method is used, with 1421 g of isopropanol being used as solvent instead of the deionized water and no milling auxiliary being employed.
E7 (comparison): A binder produced according to the general experimental method is used, with 1421 g of hexanol being used as solvent instead of the deionized water and no milling auxiliary being employed.

1. A process for the wet milling of slag,
wherein more than 100 kWh of milling energy are introduced per metric ton of slag, and the weight ratio of slag to water is 0.05-4:1; and wherein from 0.005 to 2% by weight, based on the slag, of a milling auxiliary which comprises at least one compound selected from the group consisting of polycarboxylate ether, phosphated polycondensation product, lignosulfonate, melamine-formaldehyde sulfonate, naphthalene-formaldehyde sulfonate, monoglycols, diglycols, triglycols, polyglycols, polyalcohols, alkanolamine, amino acids, sugar, molasses, and curing accelerators based on calcium silicate hydrate, is added to the material being milled before or during the wet milling.

2. The process according to claim 1, wherein the slag is blast furnace slag.

3. The process according to claim 1, wherein milling media are used in the wet milling, with the weight ratio of slag to milling media being 1-15:1.

4. The process according to claim 1, wherein the slag has the following composition:
from 20 to 50% by weight of SiO₂
from 5 to 40% by weight of Al₂O₃
from 0 to 3% by weight of Fe₂O₃
from 20 to 50% by weight of CaO
from 0 to 20% by weight of MgO
from 0 to 5% by weight of MnO
from 0 to 2% by weight of SO₃;
and >80% by weight of glass content.

5. The process according to claim 1, wherein the milling auxiliary is at least one polymer comprising acid groups selected from the group consisting of polycarboxylate ether and phosphated polycondensation product, wherein the milling auxiliary comprises a structural unit (I),
*—U—(C(O)ₖ—X-(AlkO)ₙ—W (I)
where
* indicates the point of bonding to the polymer comprising acid groups,
U is a chemical bond or an alkylene group having from 1 to 8 carbon atoms,
X is oxygen, sulfur or an NR¹ group,
k is 0 or 1,
n is an integer having an average in the range from 1 to 300,
Alk is C₂-C₄-alkylene, where Alk can be identical or different within the group (Alk-O)ₙ,
W is a hydrogen radical, a C₁-C₆-alkyl radical or an aryl radical or the group Y—F, where
Y is a linear or branched alkylene group which has from 2 to 8 carbon atoms and may optionally bear a phenyl ring,
F is a 5- to 10-membered nitrogen heterocycle which is bound via nitrogen and may optionally have, apart from the nitrogen atom and apart from carbon atoms, 1, 2 or 3 additional heteroatoms selected from oxygen, nitrogen and sulfur as ring members, where the nitrogen ring members may optionally bear an R² group and 1 or 2 carbon ring members may optionally be present as carbonyl group,
R¹ is hydrogen, C₁-C₄-alkyl or benzyl and
R² is hydrogen, C₁-C₄-alkyl or benzyl.

6. The process according to claim 5, wherein the phosphated polycondensation product comprises
(II) at least one structural unit having an aromatic or heteroaromatic group and a structural unit (I) and
(III) at least one phosphated structural unit having an aromatic or heteroaromatic group.

7. The process according to claim 6, wherein the structural units (II) and (III) are represented by the following general formulae
A-U—(C(O))ₖ—X-(AlkO)ₙ—W (II)
where
the radicals A are identical or different and are represented by a substituted or unsubstituted aromatic or heteroaromatic compound having from 5 to 10 carbon atoms in the aromatic system, where the further radicals have the meanings indicated for structural unit (I);
A-U—(C(O))ₖ—X-(AlkO)ₙ—P(O)(OMₐ)₂ (III)
where
the radicals A are identical or different and are represented by a substituted or unsubstituted aromatic or heteroaromatic compound having from 5 to 10 carbon atoms in the aromatic system, where the further radicals have the meanings indicated for structural unit (I) and
M is hydrogen, a monovalent, divalent or trivalent metal cation, an ammonium ion or an organic amine radical
a is ⅓, ½ or 1.

8. The process according to claim 6, wherein the polycondensation product comprises a further structural unit (IV) which is represented by the following formula 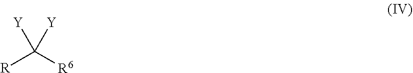
where
the radicals Y are, independently of one another, identical or different and are represented by (II), (III) or further constituents of the polycondensation product.

9. The process according to claim 5, wherein the polycarboxylate ether is at least one copolymer obtained by polymerization of a mixture of monomers comprising
(V) at least one ethylenically unsaturated monomer which comprises at least one radical selected from the group consisting of carboxylic acid, carboxylic acid salt, carboxylic ester, carboxamide, carboxylic anhydride and carboximide;
and
(VI) at least one ethylenically unsaturated monomer having a structural unit (I).

10. The process according to claim 9, wherein the ethylenically unsaturated monomer (V) is represented by at least one of the following general formulae from the group (Va), (Vb) and (Vc) 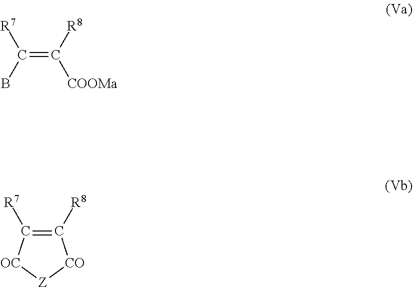
where
R⁷ and R⁸ are each, independently of one another, hydrogen or an aliphatic hydrocarbon radical having from 1 to 20 carbon atoms
B is H, —COOMₐ, —CO—O(C_{q}H_{2q}O)ᵣ—R⁹, or —CO—NH—(C_{q}H_{2q}O)ᵣ—R⁹
M is hydrogen, a monovalent, divalent or trivalent metal cation, ammonium ion or an organic amine radical
a is ⅓, ½ or 1
R⁹ is hydrogen, an aliphatic hydrocarbon radical having from 1 to 20 carbon atoms, a cycloaliphatic hydrocarbon radical having from 5 to 8 carbon atoms, or an optionally substituted aryl radical having from 6 to 14 carbon atoms
the indices q are, independently of one another, identical or different for each (C_{q}H_{2q}O)— unit and are in each case 2, 3 or 4 and
r is from 0 to 200
Z is O, NR¹⁶
the radicals R¹⁶ are, independently of one another, identical or different and are each represented by a branched or unbranched C₁-C₁₀-alkyl radical, C₅-C₈-cycloalkyl radical, aryl radical, heteroaryl radical or H, 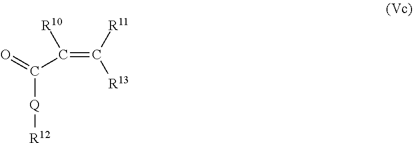
where
R¹⁰ and R¹¹ are each, independently of one another, hydrogen or an aliphatic hydrocarbon radical having from 1 to 20 carbon atoms, a cycloaliphatic hydrocarbon radical having from 5 to 8 carbon atoms, or an optionally substituted aryl radical having from 6 to 14 carbon atoms
the radicals R¹² are identical or different and are represented by (CₙH₂ₙ)—SO₃Mₐ where n=0, 1, 2, 3 or 4, (CₙH₂ₙ)—OH where n=0, 1, 2, 3 or 4; (CₙH₂ₙ)—PO₃(Mₐ)₂ where n=0, 1, 2, 3 or 4, (CₙH₂ₙ)—PO₃(Mₐ)₂ where n=0, 1, 2, 3 or 4, (C₆H₄)—SO₃Mₐ, (C₆H₄)—PO₃(Mₐ)₂, (C₆H₄)—PO₃(Mₐ)₂ or (CₙH₂ₙ)—NR¹⁴_{b} where n=0, 1, 2, 3 or 4 and b=2 or 3 and M is hydrogen, a monovalent, divalent or trivalent metal cation, ammonium ion or an organic amine radical and a is ⅓, ½ or 1
R¹³ is H, —COOMₐ, —CO—O(C_{q}H_{2q}O)ᵣ—R⁹, or —CO—NH—(C_{q}H_{2q}O)ᵣ—R⁹, where Mₐ, R⁹, q and r are as defined above
R¹⁴ is hydrogen, an aliphatic hydrocarbon radical having from 1 to 10 carbon atoms, a cycloaliphatic hydrocarbon radical having from 5 to 8 carbon atoms, or an optionally substituted aryl radical having from 6 to 14 carbon atoms,
the radicals Q are identical or different and are represented by NH, NR¹⁵ or O; where R¹⁵ is an aliphatic hydrocarbon radical having from 1 to 10 carbon atoms, a cycloaliphatic hydrocarbon radical having from 5 to 8 carbon atoms or an optionally substituted aryl radical having from 6 to 14 carbon atoms.

11. The process according to claim 1, wherein the particle size d₅₀ of the curing accelerator based on calcium silicate hydrate is less than 5 μm.

12. The process according to claim 1, wherein the wet milling is carried out in a stirred ball mill.

13. A milled slag produced according to claim 1, wherein the milled slag comprises the milling auxiliary.

14. A binder or a binder composition, having a binder component which comprises from 5 to 99% by weight of the milled slag according to claim 13 and from 1 to 95% by weight of cement.

15. A cement-based composition comprising the milled slag according to claim 13 in an amount of from 0.1 to 99% by weight based on the dry mass of the composition.

16. The process according to claim 7, wherein the polycondensation product comprises a further structural unit (IV) which is represented by the following formula 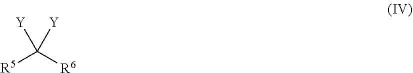
where
the radicals Y are, independently of one another, identical or different and are represented by (II), (III) or further constituents of the polycondensation product.
